(19) United States
(12) Patent Application Publication
(10) Pub. No.: US 2011/0169264 A1
(43) Pub. Date: Jul. 14, 2011

(54) Remediation of mines using pumped storage electrical generation

(76) Inventor: John Irvan Moritzky Choate, Stamford, CT (US)

(21) Appl. No.: 12/655,867

(22) Filed: Jan. 8, 2010

(51) Int. Cl. F03B 13/06

(52) U.S. Cl. 290/43

(57) ABSTRACT

A method to generate electrical power in order to provide resources to remediate and restore exhausted or abandoned mines, caves, and cavities; thereby rendering the space safer, resisting pollution, improving the environment, improving lost and useless wastelands, and allowing repetitive power generation year around at the same locations; providing employment. Alchemy is the power of transmutation by the seemingly miraculous change of a useless thing into something better, or the art of changing base elements into precious specie, or the elixir of perpetual vigor, to wit: remediation of abandoned mines, and caves, by introducing and converting to pumped storage electrical generation facilities, and for storage and manufacture of reliable, consistent, electrical power.

### PRESERVATION OF COPYRIGHT

Pursuant to 37 CFR 1.71(e): A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. All rights reserved. Copyright 2009.

### BACKGROUND OF THE INVENTION

1. Field of the Invention

The present invention is directed to using elevated cavities or quarries of caves and mines, and natural indentations, for generation of electrical energy, or preserving energy, in combination with pumped storage hydropower generator turbines; also to enable remediation and reclamation of exhausted or abandoned mines or caves; also to enable safe and economical restoration of land and property; also to secure domestic energy generation sources not susceptible to interruption and interference; also to reduce dependence on foreign energy supplies; also to improve environmental restoration; also to use wind, solar, snow, and rain sources of power for conversion into energy production; also to enable energy generation as needed and when needed—to wit: on demand; also to enable energy generation without increasing carbon dioxide emissions or damaging the ozone layer, or impacting carbon load of global warming; also to enable energy generation without reliance on radioactive or nuclear sources with the need to dispose of spent nuclear fuels, or risking radiation emissions escaping into the atmosphere; also to enable the reduction or limitation of pollution due to the flow of surface or in ground water through rock formations which provide dissolved minerals or other pollutants, which can eventually reach potable water supplies, either well or surface; also to enable transmission and distribution of power generation; and also to enable domestic employment of laborers, engineers, manufacturers, and builders.

2. Description of the Prior Art

The use of pumped storage for generation of electrical energy by hydropower turbine generators has proven to be efficient and reliable.

### A. Abandoned Mine Land Program

The need to remediate abandoned mines, and provide safety for caves or disturbed lands has been a need. There are 12,204 identified mines in the Bureau of Land Management (BLM) inventory, in thirteen western states, as of Spring 2008. This information was sifted from <www.blm.gov>. Four fifths of these sites need investigation or remediation, according to the Abandoned Mines Land program. “The AML program addresses physical safety and environmental hazards associated with abandoned hard rock mines on public lands administered by BLM. Abandoned mines addressed by the program are those that were abandoned prior to Jan. 1, 1981, the effective date of BLM's Surface Management regulations issued under authority of the Federal Land Policy and Management Act of 1976, as amended (43 U.S.C. 1701 et seq.).” A fifth to a third of the sites may pose safety hazards, and a tenth to a twentieth pose environmental hazards.

An abandoned mine is defined or described as mining operations which were not properly reclaimed, after ore was mined and eventually depleted, leaving scarred and contaminated land. Without “financially responsible parties to help pay for the cleanup” and “no current claimant of record” the “BLM must pay for and address physical safety and environmental threats.” The cost for the programs are up to $15 million annually “Risks associated with abandoned mines remain and continue to increase because more and more remote areas are being developed or accessed for recreation.”

Much of the research for mines has been directed toward sealing them, but the cost is often a major deterrent. “Even dangerous mines that have been properly sealed off are sometimes vandalized, entered, and left open. This can expose anyone nearby to unexpected, serious danger.” Physical hazards include death and serious injury by falling down open mine shafts. Health hazards include exposure to toxic gases, toxic chemicals, cave-ins, explosives and drowning in water hazard Environmental hazards include water contaminated or polluted by mine tailings which threaten potable water supplies, or destroys habitats. The objective for the abandoned mine program is to mitigate safety hazards, water quality and environmental impact, by supporting land-use planning, fisheries, wildlife biology, recreation, hazard management and resource restoration.

Many sites were for hard rock minerals which “generally include gold, silver, copper, lead, zinc, magnesium, nickel, molybdenum, tungsten, uranium, and selected other mineral.”

“In addition” to the inventory of twelve thousand sites, “there are an estimated total of 100,000-500,000 AML sites to be fully identified or characterized.” “The Forest Service (FS), the U.S. Environmental Protection Agency (EPA), the National Park Service (NPS), the Office of Surface Mining (OSM), and most mining states and tribes have their own inventories.” Government cleanup solutions include “mitigation with signs and fences, complete closure or removal of physical safety hazards, bat gating, restoration of streambeds, and removal of hazardous materials to repositories.”

The AML program has selection process and priorities for mitigation. “Priority watersheds are identified by State government agencies in their Clean Water Act reports provided to the U.S. Environmental Protection Agency. BLM prioritizes sites and projects based on a risk-based approach, and are typically located near high population centers or high-use areas.” The process includes “[1] applying risk-based watershed approaches reflecting State government priorities. [2] using risk-based approach for physical safety hazard sites. [3] coordinating with State and Federal partners. [4 planning multi-year projects] [5] focusing on priority watersheds and high-use areas. And [6] conducting peer review by program leads.” Water quality site selection factors include those with [7] avoiding and recovering costs; [8] containing impaired water quality standards; [9] reporting status of continuing projects; [10] improving watershed sites; [11] reducing threats to public safety; health and environment; [12] maintaining cost-effective partnerships; and [13] impacting locations on BLM-administered lands. Physical safety site selection factors include those with [14] reoccurring death or injury safety risks; [15] existing high public use; [16] being easily accessible; [17] existing locations near populated areas; and [18] having cost effective partnerships.

There is a history of efforts to mitigate abandoned mines as listed on the web site.

“BLM addresses physical safety hazards” associated with abandoned mine sites by: Posting warning signs and fencing off access to dangerous areas; Closing horizontal opening (adits) to keep people out. Where bats are present, BLM uses bat gates that allow bats to use the adit for habitat; Closing vertical openings (shafts) either by filling them, or by covering them with little roofs (cupolas); and/or Removing and properly disposing hazards such as mining and milling equipment, oil and chemical drums, and other debris. BLM addresses environmental hazards associated with abandoned mine sites by: Redirecting stream flow to avoid mine wastes and tailings; Capping mine waste and tailings piles located in and around stream beds, or removing and transporting them to an appropriate repository; Plugging adits to reduce or control flow of metals-laden water; Applying low-cost, low-maintenance water treatment methods; and/or Removing toxic soils impacting groundwater.

The BLM manages “258 million surface acres in 12 western states, approximately one-eighth of the total land surface in the United States.” “According to the 2000 Census, the West is the fastest growing region of the Nation, and 9 of the 12 fastest-growing States are in the West, where most BLM-managed land is located. Today, more than 63 million people live in the West, and the growth is expected to continue. Over 22 million people live within 25 miles of the public lands. From an AML standpoint, more heretofore remote sites are now in closer proximity to population centers.” “Recreation areas, national by-ways, and campground facilities on public lands can be located in proximity to AML sites. Use of Off-Highway Vehicles often transpires at AML sites amid risks of dangerous shafts, and exposure to contaminants in the soil, water and air. Recreational fishing can place anglers in proximity of AML sites, and is impacted by decreased fish population among polluted waters stemming from AML sites, and available fish may pose significant uptake of contaminants when consumed.”

Not all abandoned mines or cavities are on BLM land, but as the single largest owner, it is most concerned with this issue. As of fall 2009, power generation has not been addressed as a mitigation opportunity by BLM, or any other custodian or guardian of abandoned mines or quarries, to the knowledge of the leadership at the AML.

Exhausted mines are those who economic production of minerals is less than the cost of operation and maintenance, but which have not been abandoned by the property owner or mine owner or mineral interest patentee.

### B. Pumped Storage Program

“The benefit of pumped-storage is the ability to effectively shift capacity from periods of low energy use to periods of high energy use.” The Department of the Interior, Bureau of Reclamation.

Pumped storage has become a means to harness the advantages of solar, wind, and gravity energy generation. Solar, because as the sun evaporates the ocean waters into water vapor of clouds, the atmosphere stores the heat energy of the sun shine in the clouds. Wind, because the gulf stream and atmospheric movements shift the clouds hundreds and thousands of miles inland to fall as precipitation—either snow or rain onto all locations, including high plains, mountain ranges, and upper elevations. Gravity, because the melting snow and raindrops flow into streams and river beds, forming ponds and lakes, for the water's steady journey back to the ocean, or evaporation.

The Bureau of Land Management notes that “Potential sites for all types of hydropower exist that would double the U.S. hydroelectric production if they could be developed. However, a variety of restraints exist on this development, some natural and some imposed by our society. The natural restraints include such things as occasional unfavorable terrain for dams. Other restraints include disagreements about who should develop the resource or the resulting changes in environmental conditions. Often, other developments already exist at sites otherwise suitable for hydropower generation. Finding solutions to the problems imposed by natural restraints demands extensive engineering efforts. Sometimes no solution is possible, or is so expensive that the entire project becomes impractical. Solutions to the societal issues are frequently much more difficult to resolve and the costs are far greater than those imposed by nature. Developing the full potential of hydropower will require consideration and coordination of many varied factors.” http://www.usbr.gov/power/edu/pamphlet.pdf

Table 1, below, shows that pumped storage hydroelectric power generation is a mature technology existing in 19 states on a commercial basis, but apparently none in abandoned mines.

TABLE 1
(edited) Utilities
Hydroelectric Pumped Storage Generating Capacity
by Census Division and State - Dec. 31, 2002

| | Number | Number | |
|---|---|---|---|
| | of | Of | Pumped |
| | Pumped | Pumped | Storage |
| Census Division | Storage | Storage | Capability |
| State | Plants | Generators | (Megawatts) |
| New England | 49 | 10 | 1513.5 |
| Connecticut | 15 | 2 | 7 |
| Massachusetts | 34 | 8 | 1506.5 |
| Middle Atlantic | 182 | 30 | 2909 |
| New Jersey | 3 | 3 | 400 |
| New York | 160 | 16 | 1240 |
| Pennsylvania | 19 | 11 | 1269 |
| East North Central | | | |
| Michigan | 59 | 6 | 1978.8 |
| West North Central | | | |
| Missouri | 8 | 9 | 600.4 |
| South Atlantic | 136 | 35 | 6028.7 |
| Florida | 2 | 0 | 0 |
| Georgia | 37 | 9 | 1397.8 |
| North Carolina | 40 | 1 | 95 |
| South Carolina | 33 | 16 | 2188 |
| Virginia | 24 | 9 | 2347.9 |
| East South Central | | | |
| Tennessee | 29 | 4 | 1530 |
| West South Central | 27 | 7 | 316 |
| Arkansas | 16 | 1 | 28 |
| Oklahoma | 11 | 6 | 288 |
| Mountain | 50 | 11 | 702.6 |
| Arizona | 13 | 6 | 194.1 |
| Colorado | 37 | 5 | 508.5 |
| Pacific Contiguous | 312 | 36 | 3666.6 |
| California | 255 | 30 | 3352.6 |
| Washington | 57 | 6 | 314 |
| United States Total | 1431 | 148 | 19,245.6 |

file:///W:/f-H2O/alchemy/Bureau%20of%20Reclamation%20hydropower%20-
development%20US%20energy%20equation.htm
http://www.usbr.gov/power/edu/hydrole.html

States not listed had no pumped storage generators or capability as of the data date. The above data from the U.S. Energy Information Administration as of Dec. 31, 2002

A sample technical potential for pumped storage is described as follows:

“A pumped storage project relies on a water storage reservoir (the lower reservoir) and a second water storage reservoir at a nearby, higher elevation (the upper reservoir). The project operates by releasing water from the upper reservoir through the water conduits and turbines to the lower reservoir to generate electricity during periods of peak demand when electricity is at a premium. During periods of low electricity usage (generally during the late night hours), the turbines are reversed and used as pumps to move water to the upper reservoir for storage until needed for the next peak cycle. Pumped storage projects also provide certain dynamic benefits to electrical systems. Compared with water storage, pumped storage involves more frequent and regular pumping and generating, generally on a daily or weekly basis.” (Source p. 3-14 http://www.usbr.gov/mp/sccao/storage/docs/initial_alt_info/ta_iai_{—}02_vol2_hydropower.pdf)

The ancients imagined and studied the art of alchemy. This included the elixir of the philosopher's stone, which is described in Webster's as a hypothetical substance sought by medieval alchemists to change base metals into gold. Or, better yet, the substance called the elixir of life to prolong life indefinitely, but not just life, by youth, life with vigor, active physical and mental force or strength, a vitality, intensity and energy. This has been described as an early form of chemistry, with philosophical and magical associations, recorded and studied in the Middle Ages. This included the concept of transmutation, the change of one thing into another, a fluctuation. The common example was an attempt to turn lead, which is heavy into gold, which is heavy, or silver, which is heavy and has a color similar to lead. Webster's New World Dictionary. The nuclear age actually has identified and made the practice of transmutation, if not a common thing, a normal thing, to wit: conversion of atoms of a given element into atoms of a different isotope or different element altogether. And now with pumped storage electrical power generation as the philosopher's stone, the dream of the alchemists' imagination can come true, to turn base and useless space, of abandoned mines, into a thing of worth and value, strength, vitality, intensity and energy, that is perpetual power generation.

Reclamation noted: “Generally, all electric utilities, regardless of ownership, are subject to Federal regulations concerning air, water quality, and the protection of wildlife. They must obtain Federal licenses for hydroelectric and nuclear generation facilities, and must comply with Federal laws requiring power exchanges with qualifying small power and cogeneration producers. However, Federal agencies are not required to obtain licenses to construct or operate hydroelectric facilities”

The discovery had immediate uses for conservation, drought, employment, flood, health, hydraulics, hydrology, land use, management, performance, pollution, power, recreation, resource, restoration, safety, security, sedimentation, and water.

Legal issues include environmental concerns, ownership, permitting, water usage, pollution, etc.

FIG. 1 is a “hydroelectric generator” “courtesy of U.S. Army Corps of Engineers. USGS Water Science for Schools.”

The Corps of Engineers explains how this generator works, in part. “A hydraulic turbine converts the energy of flowing water into mechanical energy. A hydroelectric generator converts this mechanical energy into electricity. The operation of a generator is based on the principles discovered by Faraday. He found that when a magnet is moved past a conductor, it causes electricity to flow. In a large generator, electromagnets are made by circulating direct current through loops of wire wound around stacks of magnetic steel laminations. These are called field poles, and are mounted on the perimeter of the rotor. The rotor is attached to the turbine shaft, and rotates at a fixed speed. When the rotor turns, it causes the field poles (the electromagnets) to move past the conductors mounted in the stator. This, in turn, causes electricity to flow and a voltage to develop at the generator output terminals.”

http://www.nwp.usace.army.mil/HDC/edu_genexcit.asp

FIG. 2 is a pumped storage plant courtesy of the TVA.

http://www.tva.gov/power/pumpstorart.htm

“A pumped-storage plant uses two reservoirs, one located at a much higher elevation than the other. During periods of low demand for electricity, such as nights and weekends, energy is stored by reversing the turbines and pumping water from the lower to the upper reservoir. The stored water can later be released to turn the turbines and generate electricity as it flows back into the lower reservoir.” “When demand is high, water is released via a tunnel drilled through the center of the mountain to drive generators in the mountain's underground power plant.” http://www.tva.gov/sites/raccoonmt.htm

As described below, the reservoir, rather than being in a dam pre-planned for a lake, will be located in either open or enclosed cavity, exhausted or abandoned mine, or quarry. The delivery tunnel will be drilled both horizontally and vertically as required by specific sites, to connect the storage to the power generation chamber.

### SUMMARY OF THE INVENTION

It is an object of the present invention to provide a method for—

reducing cost of redmediating abandoned mines or quarries, by using pumped storage electric generation to create a reliable electrical power source;

obtaining natural advantages of gravity flow of water;

selecting a location for storage of water or other fluid, and a source for water, and a location for either discharge or storage;

drilling additional holes, channels, or spaces to deliver the water;

locating the generating and pumping equipment in a position to be activated for their uses;

moving the equipment as required for generator efficiency;

generating sufficient power;

propagating a power;

controlling the delivery of power, and receipt of power;

operating the generator and pumps upon demand;

accommodating atmospheric and weather situations;

advancing the safety and environmental requirements of the mine and pumped storage system;

operating the mine and generation system as a sufficiently repetitive activity to be economical;

monitoring the equipment's operation for safety;

covering as many areas, acres, or square (̂2) kilometers or miles of ground as available

operating in as brief time span, short enough to be useful;

operating continuously;

using elevated cavities or quarries of caves and mines, and natural indentations, for generation of electrical energy, or preserving energy, in combination with pumped storage hydropower generator turbines;

remediating and reclaiming abandoned mines or caves;

restoring safe and economical use of land and property;

securing domestic energy generation sources not susceptible to interruption and interference;

reducing dependence on foreign energy supplies;

restoring environmental balance;

using wind, solar, snow, and rain sources of power for conversion into energy production;

generating electrical energy as needed and when needed—to wit: on demand;

generating electrical energy without increasing carbon dioxide emissions or damaging the ozone layer, or impacting carbon load of global warming;

generating electrical energy without reliance on radioactive or nuclear sources with the need to dispose of spent nuclear fuels, or risking radiation emissions escaping into the atmosphere;

reducing or limiting pollution due to the flow of surface or in ground water through rock formations which provide dissolved minerals or other pollutants, which can eventually reach potable water supplies, either well or surface;

transmitting and distributing power generation;

employing domestic laborers, engineers, manufacturers, and builders;

using the pumped storage power for remediation, recovery, restoration and transmutation of economically exhausted or abandoned mines, quarries, and caves, into a useful thing, and introducing and converting to pumped storage electrical generation facilities, and for storage and manufacture of reliable, consistent, electrical power;

transmitting power generated at the site, and receiving power to operate pumps to return water to the upper storage;

renewing sources of power, on site, including wind and solar generators, to pump the water up to the upper storage location, in order to reduce external power needs, save cost, or prevent environmental losses;

creating new sources of revenue by electric power generation for exhausted mines whose economic production of minerals is less than the cost of operation and maintenance, but which have not been abandoned by the property owner or mine owner or mineral interest patentee.

### BRIEF DESCRIPTION OF THE DRAWINGS

FIG. 1 is a “hydroelectric generator” “courtesy of U.S. Army Corps of Engineers.”

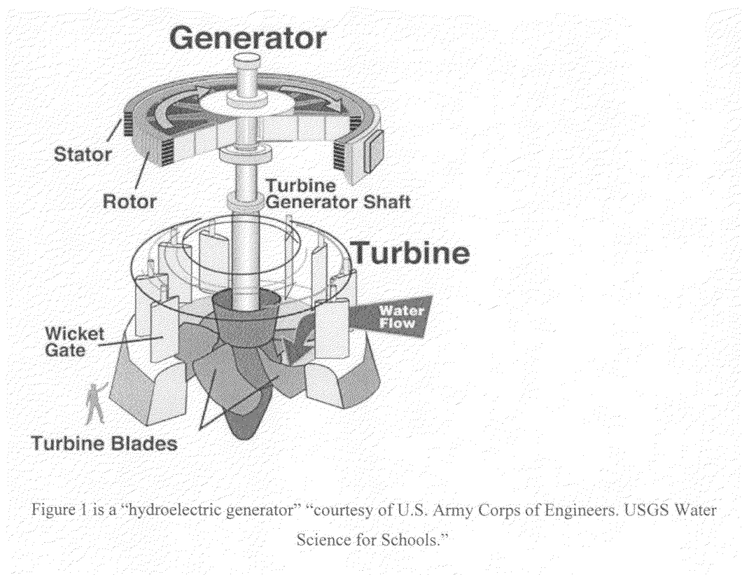

FIG. 2 is a pumped storage plant courtesy of the TVA. The excavation locations would be remediated and adapted to permit pumped storage electrical generation and distribution of power.

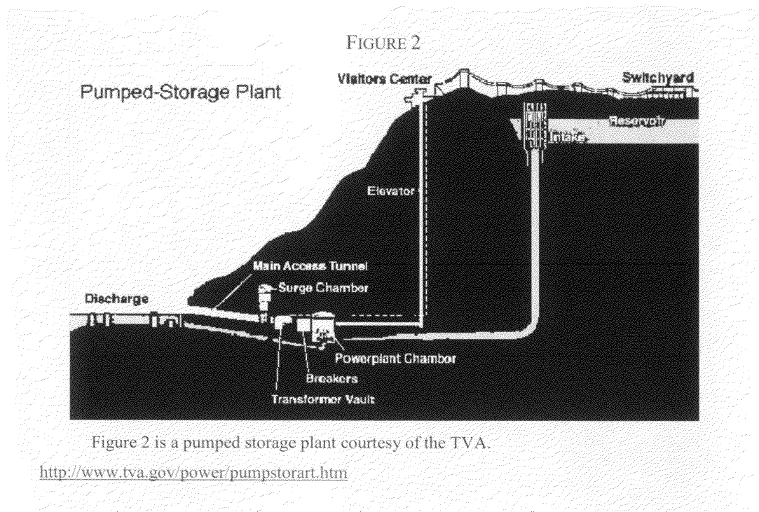

FIG. 3 shows a relationship between head, storage capacity, and theoretical hydroelectric energy generation.

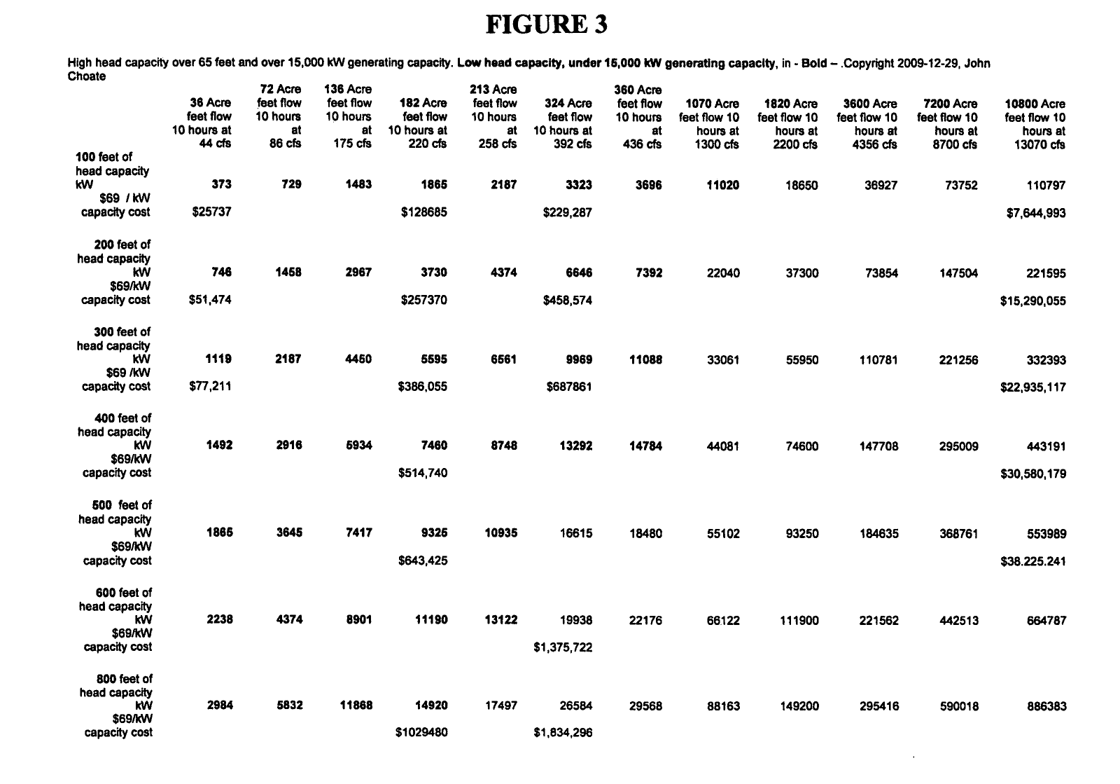

Table 1 shows that pumped storage hydroelectric power generation is a mature technology existing in 19 states on a commercial basis, but apparently none in abandoned mines.

### DETAILED DESCRIPTION OF THE INVENTION

Hydroelectric power generation combines the force of solar, wind, and water energy to produce electricity. Abandoned mines, quarries, or cavities, need restoration to improve safety and environmental concerns, yet cost of such restoration impedes their remediation. By converting these spaces into useful parts of a system to generate electricity by the pumped storage hydroelectric generation

### A. Abandoned Mine Remediation

Alchemy satisfies physical safety and environmental hazards associated with abandoned hard rock mines As the abandoned mine sites have been previously excavated, many years before, they cannot impinge upon historical sites or local cultures. Nor would there be naturally occurring fish in a mine that did not have prior access to a river or some means for fish to naturally migrate to the site. Avoiding erosion from non-existent upstream water supply, abandoned mines do not have sediment build up, filling up dam reservoirs, which is part of the life cycle of conventional capacity.

### B. Pumped Storage Power Generation

Alchemy uses water released via a tunnel drilled through the center of the abandoned mine, quarry, or cavity, on an elevation, or mountain to drive generators at the base of the underground power plant. As a subset of hydropower generation, pumped storage power is renewable. Recycling water reduces loss of capacity due to drought. Pumped storage has minimal impact on water flow, water quality, riparian habitats, aeration techniques, fish migration, flora and fauna natural habitat, air pollution, global warming,

### C. Generators

Generators permit hydraulic turbines to convert the energy of flowing water into mechanical energy. They should have no emissions.

### D. Transmission

Transmission lines to deliver power generated at the site, and to receive power to operate pumps to return water to the upper storage.

### E. Advantages of Hydropower

### file:///Volumes/H2O/alchemy/Hydroelectricity Clean Energy US EPA.htm

The use of water to create electricity does not produce a substantial amount of solid waste. Water is not polluted by the process of creating electricity.

http://www1.eere.energy.gov/windandhydro/hydro_ad.html

Hydropower is a domestic source of energy, produced in the United States.
Hydropower is a fueled by water, so it's a clean fuel source. Hydropower relies on the water cycle, which is driven by the sun, thus it's a renewable power source. Hydropower is generally available as needed; engineers can control the flow of water through the turbines to produce electricity on demand.

### F. Limitations of Abandoned Mine Pumped Storage Generation

Limitations include abandoned mines or cavities that are too small, or too low to prevent the head of water pressure to operate the generator. Recreational opportunities, notably fishing, swimming, and boating, by public access to reservoirs with dams, are not practical for pumped storage generation, and do not exist for an enclosed abandoned mine. Flood control is not a significant purpose for pumped storage generation. Water supply may be available if there is excess water storage capacity.

### G. Limitations of Dam Reservoir Hydropower (Conventional Capacity) Versus Advantages of Abandoned Mines Pumped Storage

### file:///Volumes/H2O/alchemy/Hydroelectricity Clean Energy US EPA.htm

Abandoned or economically exhausted mines with pumped storage generation do not have the problems associated with dam reservoirs and hydropower generation, or conventional capacity. All the disadvantages of hydroelectric power generation deal with dams, which disadvantages do not apply to combining storage of existing excavated mines with pumped storage generation.

If a large amount of vegetation is growing along the riverbed when a dam is built, vegetation can decay in the lake that is created, causing the buildup and release of methane, a potent greenhouse gas. Dams can greatly affect the flow of rivers, altering ecosystems and affecting the wildlife and people who depend on those waters.

Water at the bottom of the lake created by a dam is inhospitable to fish because it is much colder and oxygen-poor compared with water at the top. When this colder, oxygen-poor water is released into the river, it can kill fish living downstream that are accustomed to warmer, oxygen-rich water. Some dams withhold water and then release it all at once, causing the river downstream to suddenly flood. Water release can disrupt plant and wildlife habitats and affect drinking water supplies.

When new dams are constructed and lakes are created, dams can alter sizable portions of land by flooding land that may have once served as wildlife habitat, farmland, and scenic retreats. Dams can cause erosion along the riverbed upstream and downstream, which can disturb wildlife ecosystems and fish populations.

Dams affect fish populations. Salmon populations in the Northwest depend on rivers for their life cycles and have been dramatically reduced by the network of large dams in the Columbia River Basin. When young salmon travel downstream toward the ocean, they may be killed by turbine blades at dams. When adult salmon attempt to swim upstream to reproduce, they may not be able to get past the dams. For this reason, some dams now have special side channels or structures to help the fish continue upstream.

http://www1.eere.energy.gov/windandhydro/hydro_ad.html

Free flowing hydropower plants can be impacted by drought. When water is not available, the hydropower plants can't produce electricity.

### H. Why the Application of Pumped Storage Technology to Remediate Abandoned Mines is not Obvious

As noted, pumped storage electric generation technology is a mature industry, and thousands of abandoned mines, some 140 years old, exist in America, many under the responsibility of the Federal Government. As pumped storage solves many limitations existing in dam construction, while potentially generating revenues and power in a very favorable manner, why isn't the application of one to the other obvious? The best evidence that this has not been obvious is that it has not been done before. Why not? Perhaps because miners are not electricians, or dams are wet and mines are dry, or mines are in mountains and rivers are in valleys, mines are up and water is down, or lakes are open and mines are covered, or lakes have entrances and exits and quarries have neither, or lakes are pretty and mines are ugly, or dams are filled and mines are emptied, or mining is taught in geology engineering and dams are taught in civil engineering, or rivers have mouths and mines do not, or rivers have sources and mines do not, or river water may irrigate and mine tailings do not, or rivers may freeze and mines may not.

Or, there has not been the need. According to Bartlett's Quotations, Plato, Wycherley, and Franck wrote Necessity is the mother of all invention.

Also according to Bartlett's Quotations, neither hydroelectric, nor abandoned mine, nor quarry achieve the stature of making the short list of literary bon mots, or at least they don't make the index. Probably because no one thinks about them. That's why they were abandoned in the first place. There may be other reasons in addition to those identified.

| | 36 Acre | 72 Acre | 136 Acre | 182 Acre | 213 Acre | 324 Acre | 360 Acre |
|---|---|---|---|---|---|---|---|
| | feet flow | feet flow | feet flow | feet flow | feet flow | feet flow | feet flow |
| | 10 hours at | 10 hours at | 10 hours at | 10 hours at | 10 hours at | 10 hours at | 10 hours at |
| | 44 cfs | 86 cfs | 175 cfs | 220 cfs | 258 cfs | 392 cfs | 436 cfs |
| 100 feet of | 373 | 729 | 1483 | 1865 | 2187 | 3323 | 3696 |
| head capacity | | | | | | | |
| kW | | | | | | | |
| $69/kW | $25737 | | | $128685 | | $229,287 | |
| capacity cost | | | | | | | |
| 200 feet of | 746 | 1458 | 2967 | 3730 | 4374 | 6646 | 7392 |
| head capacity | | | | | | | |
| kW | | | | | | | |
| $69/kW | $51,474 | | | $257370 | | $458,574 | |
| capacity cost | | | | | | | |
| 300 feet of | 1119 | 2187 | 4450 | 5595 | 6561 | 9969 | 11088 |
| head capacity | | | | | | | |
| kW | | | | | | | |
| $69/kW | $77,211 | | | $386,055 | | $687861 | |
| capacity cost | | | | | | | |
| 400 feet of | 1492 | 2916 | 5934 | 7460 | 8748 | 13292 | 14784 |
| head capacity | | | | | | | |
| kW | | | | | | | |
| $69/kW | | | | $514,740 | | | |
| capacity cost | | | | | | | |
| 500 feet of | 1865 | 3645 | 7417 | 9325 | 10935 | 16615 | 18480 |
| head capacity | | | | | | | |
| kW | | | | | | | |
| $69/kW | | | | $643,425 | | | |
| capacity cost | | | | | | | |
| 600 feet of | 2238 | 4374 | 8901 | 11190 | 13122 | 19938 | 22176 |
| head capacity | | | | | | | |
| kW | | | | | | | |
| $69/kW | | | | | | $1,375,722 | |
| capacity cost | | | | | | | |
| 800 feet of | 2984 | 5832 | 11868 | 14920 | 17497 | 26584 | 29568 |
| head capacity | | | | | | | |
| kW | | | | | | | |
| $69/kW | | | | $1029480 | | $1,834,296 | |
| capacity cost | | | | | | | |
| 1000 feet of | 3730 | 7290 | 14835 | 18650 | 21871 | 33230 | 36960 |
| head capacity | | | | | | | |
| kW | | | | | | | |
| $69/kW | | | | | | $2,292,870 | |
| capacity cost | | | | | | | |
| 1400 feet of | 5222 | 10206 | 20769 | 26110 | 30619 | 46523 | 51745 |
| head capacity | | | | | | | |
| kW | | | | | | | |
| $69/kW | | | | $1,801,590 | | $3,210.087 | |
| capacity cost | | | | | | | |
| 1800 feet of | 6714 | 13122 | 26703 | 33570 | 39368 | 59815 | 66529 |
| head capacity | | | | | | | |
| kW | | | | | | | |
| $69/kW | | | | | | $4127235 | |
| capacity cost | | | | | | | |
| 2400 feet of | 8952 | 17497 | 35604 | 44760 | 52491 | 79754 | 88706 |
| head capacity | | | | | | | |
| kW | | | | | | | |

| | 1070 Acre | 1820 Acre | 3600 Acre | 7200 Acre | 10800 Acre |
|---|---|---|---|---|---|
| | feet flow | feet flow | feet flow | feet flow | feet flow |
| | 10 hours at | 10 hours at | 10 hours at | 10 hours at | 10 hours at |
| | 1300 cfs | 2200 cfs | 4356 cfs | 8700 cfs | 13070 cfs |
| 100 feet of | 11020 | 18650 | 36927 | 73752 | 110797 |
| head capacity | | | | | |
| kW | | | | | |
| $69/kW | | | | | $7,644,993 |
| capacity cost | | | | | |
| 200 feet of | 22040 | 37300 | 73854 | 147504 | 221595 |
| head capacity | | | | | |
| kW | | | | | |
| $69/kW | | | | | $15,290,055 |
| capacity cost | | | | | |
| 300 feet of | 33061 | 55950 | 110781 | 221256 | 332393 |
| head capacity | | | | | |
| kW | | | | | |
| $69/kW | | | | | $22,935,117 |
| capacity cost | | | | | |
| 400 feet of | 44081 | 74600 | 147708 | 295009 | 443191 |
| head capacity | | | | | |
| kW | | | | | |
| $69/kW | | | | | $30,580,179 |
| capacity cost | | | | | |
| 500 feet of | 55102 | 93250 | 184635 | 368761 | 553989 |
| head capacity | | | | | |
| kW | | | | | |
| $69/kW | | | | | $38.225.241 |
| capacity cost | | | | | |
| 600 feet of | 66122 | 111900 | 221562 | 442513 | 664787 |
| head capacity | | | | | |
| kW | | | | | |
| $69/kW | | | | | |
| capacity cost | | | | | |
| 800 feet of | 88163 | 149200 | 295416 | 590018 | 886383 |
| head capacity | | | | | |
| kW | | | | | |
| $69/kW | | | | | |
| capacity cost | | | | | |
| 1000 feet of | 110204 | 186500 | 369270 | 737522 | 1107979 |
| head capacity | | | | | |
| kW | | | | | |
| $69/kW | | | | | |
| capacity cost | | | | | |
| 1400 feet of | 154286 | 261100 | 516978 | 1032531 | 1551171 |
| head capacity | | | | | |
| kW | | | | | |
| $69/kW | | | | | $93,070,260 |
| capacity cost | | | | | |
| 1800 feet of | 198368 | 335700 | 664686 | 1327540 | 1994363 |
| head capacity | | | | | |
| kW | | | | | |
| $69/kW | | | | | $137,611,047 |
| capacity cost | | | | | |
| 2400 feet of | 264490 | 447600 | 886248 | 1770054 | 2659150 |
| head capacity | | | | | |
| kW | | | | | |

High head capacity over 65 feet and over 15,000 kW generating capacity. Low head capacity, under 15,000 kW generating capacity, in - Bold - . Copyright 2009 Dec. 29, John Choate
The Bureau of Reclamation estimated its cost to add a kW of hydropower capacity was $69, based on construction of dams and supporting facilities. The cost to complete a 3,000 foot deep oil or gas well is about $400,000. Assuming access to mine location is available by previously existing roads used to operate the excavations, the drilling of vertical and horizontal holes to connect the cavity to the pump generation station should be comparable cost (i.e. $400,000).
An acre foot, of 43,560 cubic feet, is approximately a cube 35 feet by 35 feet by 35 feet. A cubic mile has approximately 3,375 Thousand Acre Feet (3,375,000 cubes of 35*35*35 feet\hat{ }3).

What is claimed is:

1. A method of using a mine or cave, comprising:
identifying a mine or cave that includes elevated regions that are above an electricity-generating turbine;
identifying or creating one or more regions of the elevated regions that are able to function as one or more water reservoirs;
storing water in the elevated regions able to function as water reservoirs;
releasing the stored water through the turbine in order to generate electricity on a grid; and
at times of low demand for electricity on the grid, pumping water from a reservoir lower in elevation than the turbine to the one or more elevated reservoirs in the mine or cave.

2. The method of claim 1, wherein the mine is an abandoned mine requiring restoration.

3. The method of claim 1, wherein the mine is an operational mine with regions that are no longer in use.

4. The method of claim 1, wherein the mine includes exhausted regions whose economic production of minerals is less than the cost of operation and maintenance.

5. The method of claim 1, wherein the elevated reservoirs are created without using an above-ground dam.

6. The method of claim 1, wherein a pipeline is used to transport pumped water from the lower reservoir to the elevated reservoirs.

7. The method of claim 1, wherein the use of the turbine to generate electricity occurs at times when demand for electricity on the grid is higher than when the water is pumped from the lower reservoir to the elevated reservoirs.

8. The method of claim 1, wherein the elevated reservoirs and the lower reservoir are a closed system so that contaminants arising from previous mining activities remain in the elevated or lower reservoirs.
